(19) United States
(12) Patent Application Publication
(10) Pub. No.: US 2004/0034955 A1
(43) Pub. Date: Feb. 26, 2004

(54) Broom

(76) Inventor: Bruce Robert Townsend, Kumeu (NZ)

Correspondence Address: YOUNG & THOMPSON, 745 SOUTH 23RD STREET 2ND FLOOR, ARLINGTON, VA, 22202

(21) Appl. No.: 10/362,673

(22) PCT Filed: Aug. 22, 2001
(86) PCT No.: PCT/NZ01/00170

(30) Foreign Application Priority Data
Aug. 22, 2000 (AU) 506457

(51) Int. Cl. A46B 15/00; B25G 3/38

(52) U.S. Cl. 15/144.1; 15/172

(57) ABSTRACT

A mounting means for connecting a broom handle (18) to a broom head (10). The mounting means includes a bracket (15) non-rotatably connected to the broom head (10). The bracket is also pivotally connected to said handle (18) about an axis (19) which is substantially at right angles to the main axis of the broom head (10) and is angled with respect to the axis of the handle (18) and broom head (10) so that greater manoeuvability of the broom is achieved.

### FIELD OF THE INVENTION

This invention relates to mounting means for tools, such as brooms, mops, brushes, rollers and the like.

### BACKGROUND

Hitherto, broom heads have generally been rigidly mounted on a rigid handle. Whilst the rigid mounting of the broom head to the handle generally provides for a more durable connection, brooms having such a rigid mounting means have been found to have limited manoeuvrability. There have been attempts to provide mounting means having greater manoeuvrability. For example, the head of a dusting or polishing mop has been connected to a handle by a universal joint.

The use of a universal joint is not suitable for a broom however, as the broom head will rotate uncontrollably during sweeping, making it difficult if not impossible to sweep with the broom. This is not so with dust mops which are generally drawn or pushed in continuous contact with the floor.

Additionally, prior art attempts at providing mounting means capable of greater manoeuvrability provide mounting means that are less durable and wear more easily. It is well known the connection between a broom head and broom handle is normally a point of weakness and commonly requires maintenance.

There is a need for a tool such as a broom, which has durable mounting means between the head and handle and is capable of being used in corners, and on walls, floors and the like.

### OBJECT

It is an object of this invention to provide an improved mounting means for a tool such as a broom, or one which will at least provide the public with a useful choice.

### STATEMENT OF INVENTION

In one aspect the invention provides a mounting means for connecting a cleaning tool head with a cleaning tool handle, wherein the cleaning tool head is capable of pivotal movement relative the cleaning tool handle.

Preferably the mounting means includes a bracket.

Preferably the bracket is not rotatable relative the cleaning tool head.

Preferably the bracket is either U- or J-shaped

Preferably the mounting means includes means for connecting the bracket with the cleaning tool head.

Preferably the mounting means includes means for securing the cleaning tool handle with the bracket.

More preferably the invention provides mounting means for a cleaning tool including a bracket, means for pivotally connecting said bracket to a handle at angle to the axis of the handle, and means for non-rotatably connecting said bracket to a head of a cleaning tool, so that in use, the head is pivotally connected to the handle.

In another aspect, the invention provides a cleaning tool having a handle, and a head attached to said head, wherein said handle is pivotally connected to said handle about an axis which is substantially at right angles to the main axis of the cleaning head and is angled with respect to the axis of the handle.

Preferably the cleaning tool is a broom.

### BRIEF DESCRIPTION OF THE DRAWINGS

Other aspects of this invention which should be considered in all its novel aspects, will become apparent from the following description which is given by way of example only, with reference to the accompanying drawings, in which:

FIG. 1. illustrates a preferred broom in side elevation.

FIG. 2. illustrates the broom of FIG. 1 in front elevation.

### PREFERRED EMBODIMENT

This invention relates to brooms or other tools, in which the tool head is moved along a surface and may be repeatedly lifted from the surface as is the case with brooms and paint brushes.

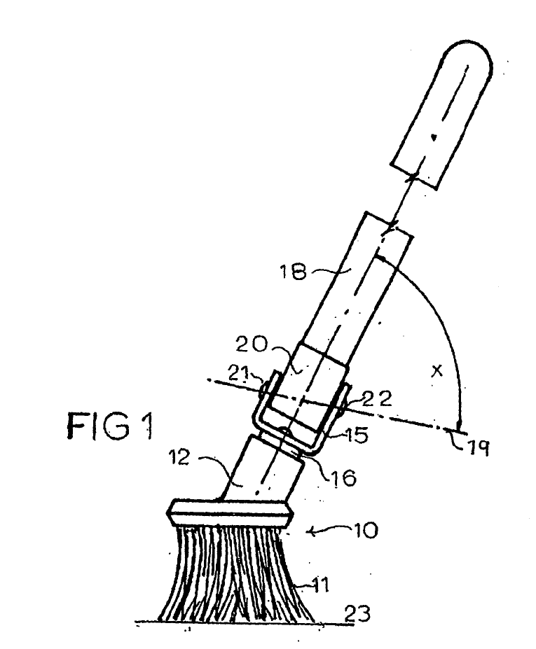

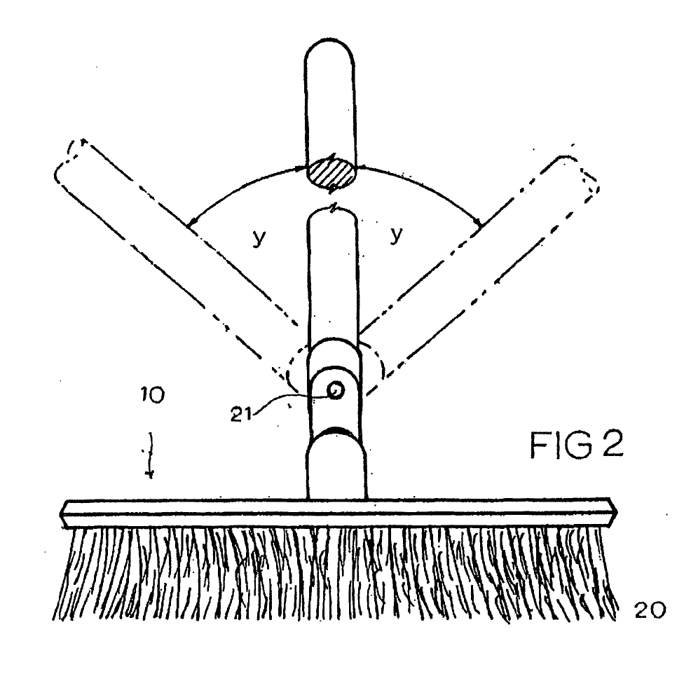

FIGS. 1 and 2 show a broom having a substantially rectangular broom head 10 with a plurality of bristles 11 attached thereto. The broom head 10 has a socket 12 inclined rear-wardly with respect to the broom head head 10.

A substantially U- or J-shaped bracket 15 is attached to a socket 12. A downwardly depending plug 16 is non-rotatably attached to the bracket 15. The bracket 15 is non-rotatably attached to the socket 12. The rotation of the bracket is prevented by providing a socket 12 with internal splines (not shown), and the plug 16 with complimentary splines (not shown). This allows a friction fit within the socket 12 in a non-rotatable fashion.

The bracket 15 is pivotally connected to a handle 18 about a pivot axis 19., Conveniently, a socket 20 is provided capable of engaging the end of the handle 18. The socket 20 is attached to the bracket 15 by a single pivot pin or by a pair of pivot pins 21, 22 extending into the sides of the socket 20 as shown.

By this means, the broom head 10 is connected to the handle 18 by a pivotal connection about axis 19.

The pivot axis 19 is such that in use rotation of the handle 18 will cause the broom head 10 to rotate whilst at the same time, the bristles 11 are maintained in contact with the working surface. The axis 19 is inclined at an angle X of less than 90° with respect to the handle 18. It has been found an angle X of about 74° is particularly effective.

By placing the bottom of socket 20 close to the bottom of the bracket 15, rotation of the broom head in respect to the handle 18 will be limited, as the bottom of the bracket 15 will contact the bottom of the handle 18. These limits are shown by angle Y in FIG. 2. The limitations are advantageous if the broom is to be used on a wall or the like. However, they may be omitted if the broom is used at shallow angles to the floor, for example in sweeping under furniture In use, the broom can be used to sweep the floor in a conventional fashion. In addition the broom may be used to sweep into comers and along the edges of a working surface by rotating the handle to rotate the broom head 10 to a desired position. In addition, the broom can be used to sweep vertical surfaces such as walls or windows, in either a side to side or up and down fashion as devised by the operator.

The versatility of the broom is achieved by the single pivot axis in which the axis is inclined at an acute angle with respect to the handle of the broom.

It is to be understood that the angles referred to herein are given by way of illustration only, although they have been found to be particularly satisfactory in the case of the broom illustrated in the drawing.

### ADVANTAGES

The present invention provides an improved cleaning tool having more manoeuvrability than prior art cleaning tools.

In addition, the present invention provides a mounting means that is durable.

### VARIATIONS

Finally, it will be appreciated that various alterations or modifications may be made to the foregoing without departing from the spirit or scope of this invention.

It will be appreciated that the broom head 10 could be replaced by the head of an other tool, such as a dust mop, washing mop, window cleaning tool, scraper, paint brush, roller, or the like. In addition, the means for attaching the broom handle to the bracket means may be varied. Instead of using a single pivot pin traversing the diameter of the broom handle the invention may be varied to use more than one pin. The one or more pins might only penetrate a limited distance into the broom handle.

Throughout the description and claims of this specification the word “comprise” and variations of that word, such as “comprises” and “comprising”, are not intended to exclude other additives, components, integers or steps.

I claim:

1. A mounting means for connecting a cleaning tool head with a cleaning tool handle, wherein the cleaning tool head is capable of pivotal movement relative the cleaning tool handle.

2. A mounting means as claimed in claim 1, wherein said cleaning tool handle is pivotally connected to said handle about an axis which is substantially at right angles to the main axis of the cleaning head and is angled with respect to the axis of the handle.

3. A mounting means as claimed in claim 1, wherein the mounting means includes a bracket.

4. A mounting means as claimed in claim 3 wherein the bracket is not rotatable relative the cleaning tool head.

5. A mounting means as claimed in claim 3, wherein the bracket is either U- or J-shaped.

6. A mounting means as claimed in claim 1 wherein the mounting means includes means for connecting the bracket with the cleaning tool head.

7. A mounting means as claimed in claim 1, wherein the mounting means includes means for securing the cleaning tool handle with the bracket.

8. A mounting means as claimed in any of the previous claims, wherein the cleaning tool is a broom.

9. A broom comprising a broom head, a broom handle and a mounting means as claimed in any of the previous claims.
